(19) United States
(12) Patent Application Publication
(10) Pub. No.: US 2012/0209153 A1
(43) Pub. Date: Aug. 16, 2012

(54) DEEP VEIN THROMBOSIS THERAPY DEVICE

(76) Inventors: Mark A. FARROW, Tulsa, OK (US); Joey ADKINS, Hinckley, OH (US)

(21) Appl. No.: 13/396,331

(22) Filed: Feb. 14, 2012

Related U.S. Application Data
(60) Provisional application No. 61/442,392, filed on Feb. 14, 2011.

(51) Int. Cl. A61H 1/00; A61H 19/00

(52) U.S. Cl. 601/18; 601/149

(57) ABSTRACT

A compression therapy system for treating deep vein thrombosis in disclosed. The system provides sequential, graduated compression to a selected limb or body part. The system includes a portable compression device having multiple outlets. In one embodiment, up to three outputs may be selectively activated by a user. The wraps may be provided with cold therapy wraps. In a second embodiment, the system utilizes a timer to determine which, if any, of several wraps may be attached and inflates a detected wrap to a correct pressure or powers off the system as may be appropriate.

### CROSS REFERENCE TO RELATED APPLICATIONS

This application claims the priority of U.S. Provisional Patent Application No. 61/442,392 entitled “DEEP VEIN THROMBOSIS THERAPY DEVICE,” filed Feb. 14, 2011, the contents of which are hereby incorporated by reference.

### FIELD OF THE INVENTION

The present invention relates to therapeutic medical devices and more particularly to devices for improving venous blood flow in a patient.

### BACKGROUND OF THE INVENTION

Deep vein thrombosis (DVT) affects up to two million people in the United States each year. DVT is the formation of a blood clot or thrombus in a deep vein, such as the femoral vein or the popliteal vein, or the deep veins of the pelvis. More rarely, veins of the arm can be affected, such as in Paget-Schrötter disease. A DVT can occur without symptoms, but the affected extremity will oftentimes be painful, swollen, red, and warm, and the superficial veins may be engorged. A serious complication of a DVT is that a clot could dislodge and travel to the lungs, resulting in a pulmonary embolism.

Intermittent pneumatic compression can be of benefit to patients deemed to be at risk of deep vein thrombosis. Therefore it is desirable to provide a system for using pneumatic compression that a patient can easily self administer.

### SUMMARY OF THE INVENTION

In one embodiment, the device of the invention is a portable battery-operated compression machine that provides Deep Vein Thrombosis (DVT) prophylaxis therapy, i.e., cold and compression to body parts. The device includes a compression pump that is located within a housing along with electronics that control pump operation. The compression pump is used to selectively inflate a first and a second Sequential Compression Device (SCD) sleeve that are typically placed on a patient's calves, although other body parts may also receive therapy including a patient's knee, foot, shoulder, or other area. The device has three output ports and includes a selector that allows a user to choose one of several settings. For example, settings include “single limb cuff”, “double limb cuff”, “auxiliary cuff only”, and “single limb and auxiliary cuff”, and “double limb and auxiliary cuff”. The auxiliary cuff is preferably suitable for locating on a patient's joint, another limb, e.g., a patient's arm, or elsewhere. In use, the sleeves preferably inflate one at a time up to a preset pressure at a desired time interval, e.g., 50 mmHg every 60 seconds.

In one embodiment, the device has two output ports. User control is limited to an ON/OFF function. Appropriate wraps containing air bladders are connected to the unit via the two externally accessible air output ports. The control unit fills the wraps to a pre-determined pressure, e.g., 50 mmHg for a larger wrap and 130 mmHg for a smaller wrap. For example, wraps include a large wrap for affixing to a leg of a patient and a smaller wrap for affixing to a foot or ankle of a patient. Although various types of wrap configurations adapted for use on various body parts and combinations of wraps are possible, for purposes of example, “leg wrap” will be used as an example of a larger wrap and “foot wrap” will be used as an example of a smaller wrap. Preferably, a plurality of indicators, e.g., LEDs, are provided on the unit wherein the indicators correspond to an output port. The indicators preferably illuminate solid at the initiation of a fill cycle and remain illuminated solid if a leg wrap is determined to be connected, or alternatively flashes slowly if a foot wrap is determined to be connected to an output. Once a wrap is inflated to a desired pressure level, the pump and corresponding solenoid valve are turned off for a “rest” period of a pre-determined duration. The wrap then deflates through a normally open vent port of the solenoid valve. After the rest period, the next wrap is sequenced, and so on.

A preferred rest time is approximately 60 seconds between cycles for each output. Therefore, when an inflation cycle through a first output is completed or the device is otherwise reset due to no wrap being detected, then a second output will be cycled on after 25 seconds. When the second output completes its inflation, or is otherwise reset due to no wrap being detected, the first output will again be cycled after 25 seconds, and so on. Therefore, in a preferred embodiment, the time between any single output being turned off and the time the same output is again energized is greater than 50 seconds.

The device of the invention may be used to provide therapy that is beneficial for patients after surgery to alleviate pain and swelling. Typically, the device is prescribed by a physician for an individual patient who has a high risk of getting DVT due to non-ambulation during and after surgery. The patient will typically use the device for a time period of a few hours up to several weeks depending on the doctor's prescription.

A cold therapy wrap may also be placed on the affected extremity for DVT prophylasis. The cold therapy wrap preferably inflates from 20 to 50 mmHg. The cold therapy wrap is preferably gel filled.

### BRIEF DESCRIPTION OF THE DRAWINGS

FIG. 1 is a schematic of one embodiment of the cold therapy system of the invention applied to a patient.

FIG. 2 is a plan view of a first embodiment of the device of the invention.

FIG. 3 is a side view of the device of FIG. 2.

FIG. 4 is a bottom view of the device of FIG. 2.

FIG. 5 is an exploded view of the device of FIG. 2.

FIG. 6 is a plan view of a second embodiment of the device of the invention.

FIG. 7 is a schematic of the components of the device of FIG. 6.

FIG. 8 is a plan view of a limb wrap for connection to the devices of FIGS. 1 and 6.

FIG. 9 is a plan view of an outer side of a shoulder wrap for connection to the devices of FIG. 1.

FIG. 10 is a plan view of the inner side of the shoulder wrap of FIG. 9 for connection to the devices of FIG. 1.

FIG. 11 is a plan view of an inner side of the cold knee wrap of FIG. 1.

FIG. 12 is a plan view of an outer side of the cold knee wrap of FIG. 11.

### DETAILED DESCRIPTION OF THE PREFERRED EMBODIMENTS

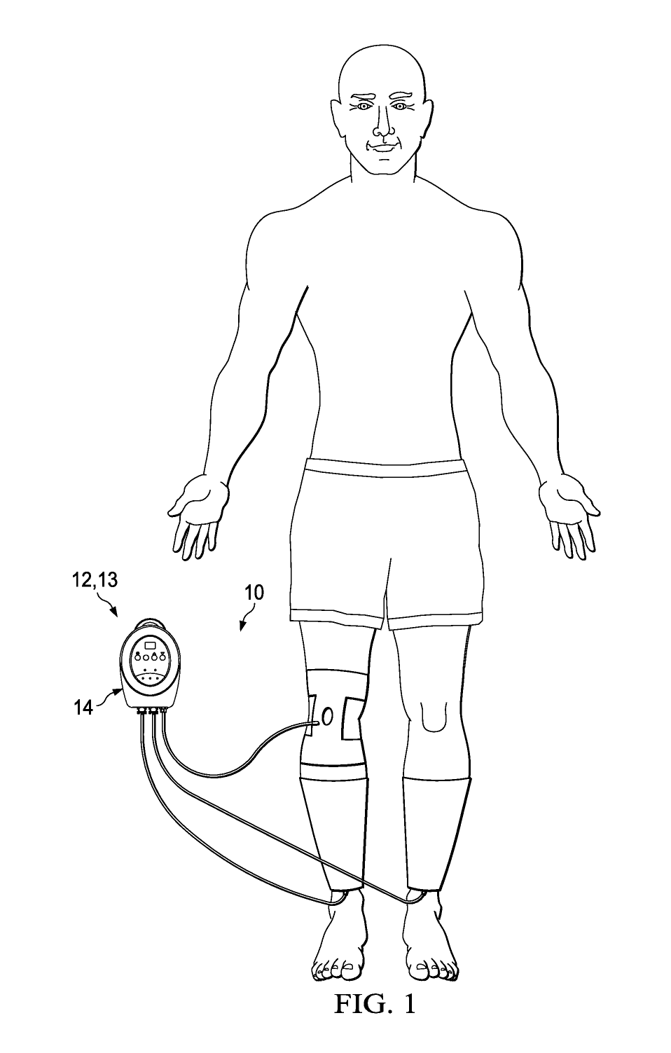

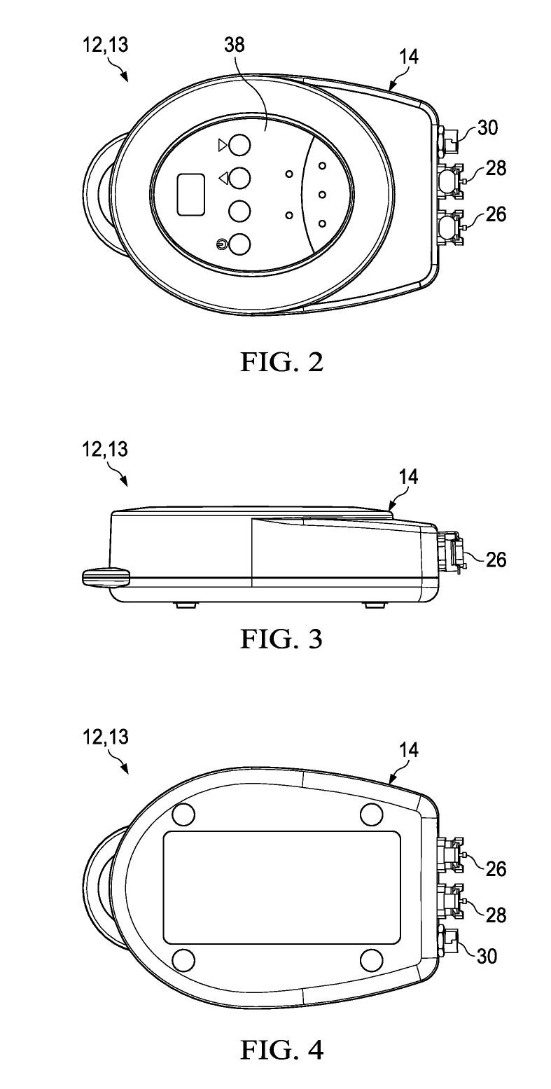

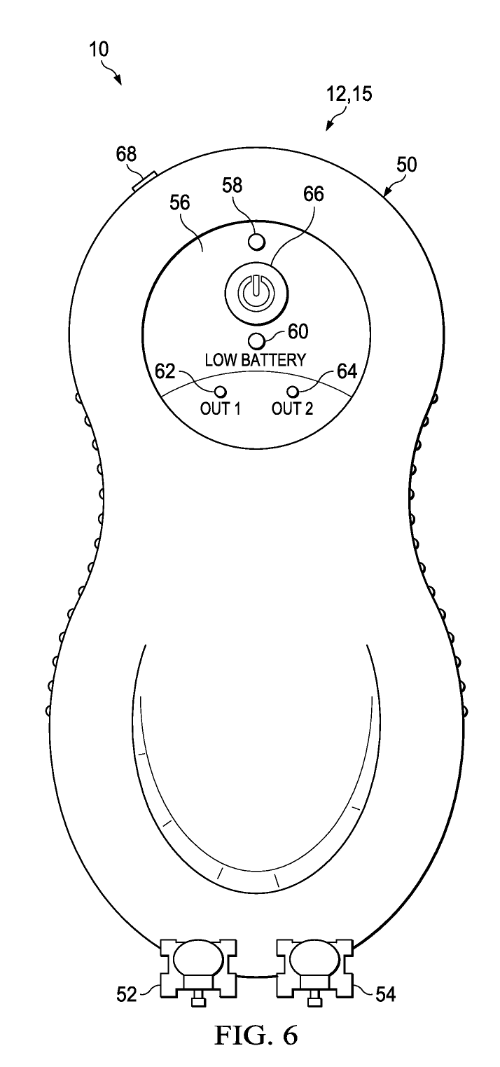

Referring now to FIG. 1, shown is a compression therapy system designated generally 10. Compression therapy system 10 includes a portable compression assembly 12 (FIGS. 1-6) having a housing 14. Examples of portable compression assembly 12 include device 13 (FIGS. 1-5) and device 15 (FIG. 6).

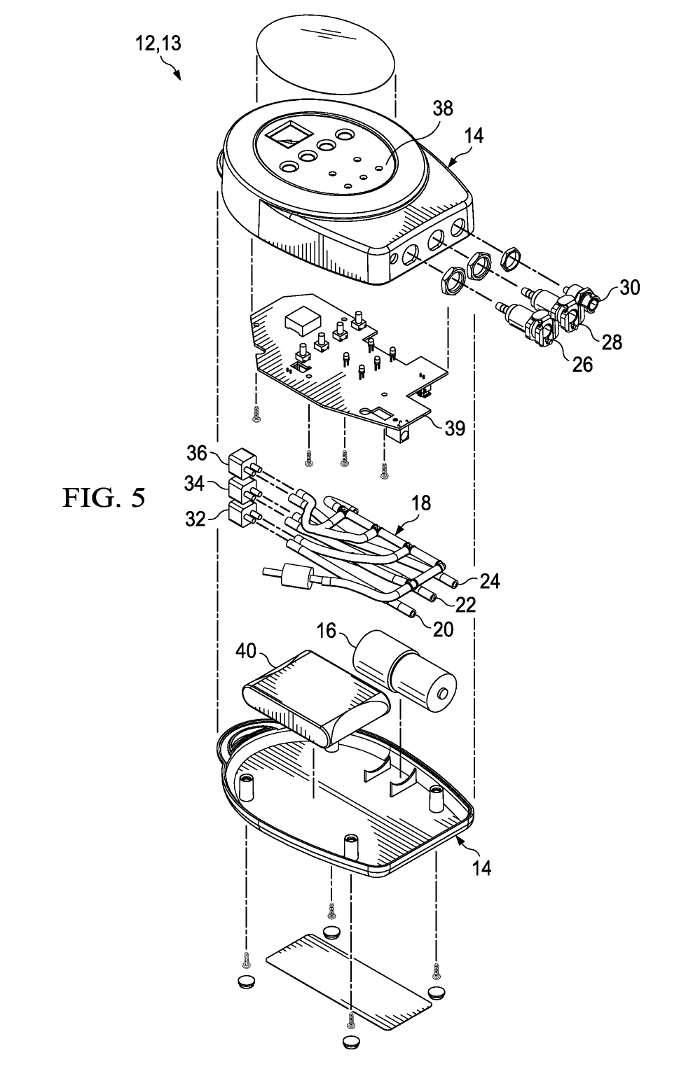

Referring first to device 13, pump 16 (FIG. 5) is located in housing 14. Tubing assembly 18 is located in housing 14. Tubing assembly 18 is provided for receiving compressed air from pump 16. Tubing assembly 18 preferably defines a first output 20, second output 22, and third output 24. First output 20 connects to first connector 26 that protrudes from housing 14. Second output 22 is connected to second connector 28, which protrudes from housing 14. Third output 24 connects to third connector 30, which protrudes from housing 14. First solenoid 32 is in communication with tubing assembly 18 for selectively routing compressed air from pump 16 to first connector 26. Second solenoid 34 is in communication with tubing assembly 18 for selectively routing compressed air from pump 16 to second connector 28. Third solenoid 36 is in communication with tubing assembly 18 for selectively routing compressed air from pump 16 to third connector 30.

Selector 38 is preferably provided on exterior of housing 14 to be accessible by a user for controlling solenoids 32, 34, 36. Selector 38 communicates with electronics board 39 for facilitating control of pump 16, solenoids 32, 34, 36 and other components. Battery 40 is in communication with pump 16 for providing power to pump 16.

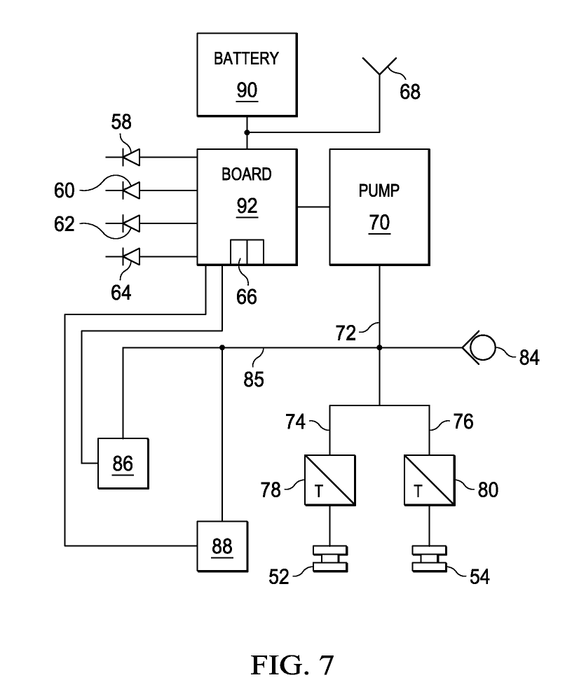

Referring now to device 15 of FIGS. 6 and 7, control unit 15 of compression system 10 preferably has housing 50. First output port 52 and a second output port 54 extend from housing 50. Output ports 52 and 54 are preferably normally closed valved connectors. Control unit 15 is preferably provided with a face 56 that displays a power indicator, e.g., LED 58, a low battery indicator, e.g., LED 60, a first output indicator, e.g., LED 62, and a second output indicator, e.g., LED 64. In a preferred embodiment, power switch 66 is also provided on face 56. Housing 50 preferably also defines an access port to receive power into power input 68.

Referring now to FIG. 7, housing 50 contains a motorized air pump 70 that supplies pressurized air to air passageway 72. Air passageway 72 splits into a first passageway 74 and a second passageway 76. A first 3-way solenoid valve 78 is provided on first passageway 74. A second 3-way solenoid valve 80 is provided on second passageway 76. A pressure relief check valve 84 is provided upstream of valves 78 and 80, preferably on air passageway 72. In one embodiment, pressure relief check valve 84 is set with a 3 psi lift pressure.

First pressure switch 86 and second pressure switch 88 monitor pressure on line 85, which communicates with line 72. Pressure switches 86 and 88 provide switched signals to MPU of board 92 as pressure in line 72 reaches a preset trigger level.

First pressure switch 86 is preferably set to have a trigger level at 50 mmHg. A second pressure switch 88 is located on line 85 upstream of second valve 80. Second pressure switch 88 is preferably set to have a trigger level at 130 mmHg. As will be explained in greater detail below, the MPU of board 92 monitors the time for each of switch 86 and 88 to reach the respective trigger level. The time required to read a trigger level is indicative of the volume, and therefore the type, of bladder that is connected to the output 52 or 54 associated with an active one of solenoids 78, 80. If no bladder is connected to an active one of output ports 52 or 54, the result will be an instant pressure rise due to the normally closed valved connectors of output ports 52, 54 when pump 70 is activated. If no wraps are connected to output ports 52, 54, then lines 72, 76 will remain blocked. The instant pressure rise indicates “no bladder connected” and the MPU of board 92 will advance to the next step.

Battery pack 90, preferably made up of 4 AA cells, is provided as one power source. Alternatively, device 15 can receive power externally via power input 68. Control circuit board 92 receives power from battery pack 90 or from power input 68.

In operation, the user control is limited to manipulating power switch 66 into one of an “On” position or an “Off” position. Appropriate “wraps” containing air bladders, discussed in greater detail below, are connected to unit 15 via externally accessible ports or outputs 52 or 54. Control unit 15 fills the wraps to a pre-determined pressure, e.g., 50 mmHg for relatively larger leg wraps and 130 mmHg for relatively smaller foot wraps.

The appropriate output indicator, e.g., LED 62 or 64, that corresponds to the activated wrap output illuminates “solid” at the initiation of a fill cycle, then remains illuminated solid if a leg wrap is detected or, alternatively begins flashing slowly if a foot wrap is detected on the output. Once pressure reaches a desired level, pump 70 and the corresponding valve, e.g., solenoid valve 78 or 80, is turned off for a “rest” period of a pre-determined duration. Solenoid valves 78, 80 are preferably “3 way”, with the output being common, a normally closed connection to the valve input from the pump and a normally open connection being an exhaust to the atmosphere. The wrap then deflates through normally open vent port of the solenoid valve 78, 80. After the “rest” period, the next wrap is sequenced, and so on.

The “rest” time is preferably approximately 60 seconds between cycles for each output. Therefore, when air pressure delivered through output 52 completes inflation of an attached wrap or otherwise is reset due to no wrap being detected, output 54 will be cycled after 25 seconds. When air pressure delivered through output 54 completes inflation of an attached wrap or otherwise is reset due to no wrap being detected, output 52 will then again be cycled after 25 seconds, and so on.

When battery 90 or external power is initially applied to the unit via power input 68, MPU on board 92 wakes up in “off” mode.

Power switch 66 is always active, and preferably requires being held depressed for 1 second to operate. When power switch 66 is in an “off” position, a very low current drain takes place. When power switch 66 is in an “on” position, board 92 powers up and illuminates the green Power “on” indicator 58 unless low battery conditions exist, in which case only the yellow, low battery indicator 60 will illuminate.

A delay, e.g., of three seconds, is provided before any action of pump 70 or solenoid valves 78 or 80 is provided to allow a user time to verify proper wrap connection and unit operation.

In one embodiment, device 15 operates as follows:

I. Wrap Inquiry

The first output 52 is activated and first output LED 62 illuminates “solid”. Solenoid valve 78 is then powered “on” followed by pump 70 turning on, preferable less than one second later. If low pressure switch 86 provides a signal to board 92 indicating a target pressure, e.g., 50 mm Hg has been reached within a short time period, e.g., in less than a time T₁, e.g., 0.5 seconds after pump 70 starts, board 92 determines that there is no wrap connected to port 52. First output LED 62, pump 70 and solenoid valve 78 are then turned off. Second output 54 will then be activated at a later time, e.g., 25 seconds later.

II. High Pressure Inquiry

If the low pressure switch 86 provides a signal to board 92 indicating the target pressure, e.g., 50 mm Hg has been reached in a designated time window, e.g., greater than T₁ seconds but less than T₂ seconds, e.g., greater than 0.5 but less than 1.25 seconds, the board 92 determines that a high pressure alarm condition exists, e.g., due to a kinked hose. This condition will cause the first output LED 62 to flash rapidly and sound an audible alarm. Solenoid valve 78 and pump 70 are immediately turned off. The alarm will continue for a period of time, e.g., 2 minutes, and then board 92 of unit 15 will power off unless reset manually by turning unit 15 off via power switch 66 during the alarm.

III. Wrap Determination

If the low pressure switch 86 does not provide a signal to board 92 indicating that a trigger pressure, e.g., 50 mm Hg, has been reached within a designated period of time T₃, e.g., less than 4.5 seconds, board 92 determines that the wrap connected to first output 52 is a relatively large calf wrap instead of a comparably smaller foot wrap. Pump 70 will continue to run until low pressure switch 86 provides a signal to board 92 indicating that a trigger pressure, e.g., 50 mm Hg, has been reached, indicating the end of the first output cycle, i.e., wherein port 52 is active. Then, the second output cycle begins, i.e., wherein port 54 will be activated preferably 25 seconds later.

IV. Leak Determination

If the low pressure switch 86 does not provide a signal to board 92 indicating that a trigger pressure, e.g., 50 mm Hg, has been reached within a designated period of time T₄, e.g., 25 seconds, the board 92 determines that a low pressure alarm condition exists, e.g., due to a leak. This condition will cause the first output LED 62 to flash rapidly and sound an audible alarm. Solenoid valve 78 and pump 70 are immediately turned off. This alarm will continue for a period of time, e.g., 2 minutes, and then board 92 will power off unless reset by manually turning unit 15 off via power switch 66 during the alarm.

V. Wrap Determination

If the low pressure switch 86 provides a signal to board 92 indicating that a trigger pressure, e.g., 50 mm Hg, has been reached in a designated time window, e.g., greater than T₂ seconds but less than T₃ seconds, e.g., greater than 1.25 but less than 4.5 seconds, board 92 determines that a wrap connected is a foot wrap. At this point, the first output LED 62 begins flashing slowly, and the pump 70 will continue to run until the high pressure switch 88 provides a signal to board 92 indicating that a target pressure, e.g., 130 mm Hg has been reached, indicating the end of the first output cycle, i.e., wherein port 52 is active. Second output 54 will be activated for a period of time, e.g., 25 seconds later.

VI. Leak Determination

If, after entering the foot wrap state, high pressure switch 88 does not provide a signal to board 92 indicating that a trigger pressure, e.g., 130 mm Hg, has been reached within an additional period of time T₅, e.g., 15 seconds of run time, board 92 again detects a leak alarm condition. This condition will cause the first output LED 62 to flash rapidly and sound the audible alarm. Solenoid valve 78 and pump 70 are immediately turned off. This alarm will continue for a period of time, e.g., 2 minutes, and then board 92 will power off unless reset manually by turning unit 15 off via switch 66 during the alarm.

VII. Second Output Wrap Determination

When the second output 54 activates, second output LED 64 illuminates solid. Solenoid valve 80 is powered on followed by pump 70 turning on, preferably less than one second later. If high pressure switch 88, provides a signal to board 92 indicating that a trigger pressure, e.g., 130 mm Hg, has been reached within a short time period T₁, e.g., in less than 0.5 seconds after pump 70 starts, board 92 determines that there is no wrap connected. Second output LED 64, pump 70 and solenoid valve 78 are turned off, and first output 52 will be activated at a later time, e.g., 25 seconds later.

VIII. High Pressure Determination

If the low pressure switch 86 provides a signal to board 92 indicating that a trigger pressure, e.g., 50 mm Hg, has been reached within a designated time window, e.g., greater than T₁ seconds but less than T₂ seconds, e.g., greater than 0.5 seconds but less than 4.5 seconds, the board 92 determines that a high pressure alarm condition exists, e.g., due to a kinked hose. This condition will cause the second output LED 64 to flash rapidly and sound an audible alarm. Solenoid valve 80 and pump 70 are immediately turned off. This alarm will continue for a period of time, e.g., 2 minutes, and then board 92 will power off unless reset by manually turning the unit 15 off via power switch 66 during the alarm.

IX. Wrap Determination

If the low pressure switch 86 does not close within a designated period of time T₃, e.g., less than 4.5 seconds, a determination is made that the wrap connected to second output 54 is a larger wrap, e.g., a calf wrap, which possesses a relatively larger bladder, and pump 70 will continue to run until the low pressure switch 86 provides a signal to board 92 indicating that a trigger pressure, e.g., 50 mm Hg, has been reached, indicating the end of the second output cycle. First output 52 will then be activated after a designated period of time, e.g., 25 seconds later.

X. Low Pressure Determination

If low pressure switch 86 does not provide a signal to board 92 indicating that a trigger pressure, e.g., 50 mm Hg, has been reached within a designated period of time, e.g., 25 seconds, the board 92 determines that a low pressure alarm condition exists, e.g., due to a leak. This condition will cause the second output LED 64 to flash rapidly and sound an audible alarm. Solenoid valve 80 and pump 70 are immediately turned off. This alarm will continue for a period of time, e.g., 2 minutes, and then board 92 will power off unless reset manually by turning the unit 15 off via power switch 66 during the alarm.

XI. Small Wrap Determination

If low pressure switch 86 provides a signal to board 92 indicating that a trigger pressure, e.g., 50 mm Hg, has been reached in a designated period of time, e.g., greater than 1.5 seconds but less than 4.5 seconds, board 92 makes the determination that the wrap connected to port 52 is a foot wrap. At this point, the second output LED 64 begins flashing slowly. Pump 70 continues to run until high pressure switch 88 provides a signal to board 92 indicating that a trigger pressure, e.g., 130 mm Hg, has been reached, indicating the end of the second output cycle. The first output 52 will be activated a designated period of time, e.g., 25 seconds later.

XII. Leak Detection

If, after entering the “foot wrap” state, the high pressure switch 88 does not provide a signal to board 92 indicating that a trigger pressure, e.g., 130 mm Hg, has been reached within an additional period of time, e.g., within 15 seconds, board 92 will again detect a leak alarm condition. This condition will cause the second output LED 64 to flash rapidly and sound an audible alarm. Solenoid valve 80 and pump 70 are immediately turned off. The alarm will continue for a period of time, e.g., 2 minutes, and then board 92 will power off unless reset by manually turning the unit 15 off via power switch 66 during the alarm.

Unit 15 is normally powered via an external AC adapter via power input 68 with battery power pack 90 being available for temporary use. Both sources provide power to the same bus circuit of board 92. If the voltage on the bus line drops below a certain value, e.g., below 6 volts, while unit 15 is on, the yellow low battery indicator 60 illuminates. If voltage on the line drops further to below a second value, e.g., below 5.5 volts, while unit 15 is on, unit 15 enters into a “lockout” mode wherein yellow LED 60 remains on, but power LED 58 is turned off. All functions except power switch 66 are then inhibited, i.e., put in lockout mode. In lockout mode, power switch 66 can be used to turn the unit 15 fully off, but if an attempt is made to turn unit 15 back to on while bus line is still below the second value, e.g., 5.5 volts, only the yellow LED 60 is illuminated. The MPU on board 92 can switch from “off” to “lockout”, but not to “on” unless voltage on bus line is above the second value, e.g., above the 5.5 volt threshold.

To reset an alarm condition, switch 66 must be turned off. If switch 66 is not manually turned off within a designated period of time, e.g., 2 minutes of an alarm condition occurring, unit 15 automatically turns itself off.

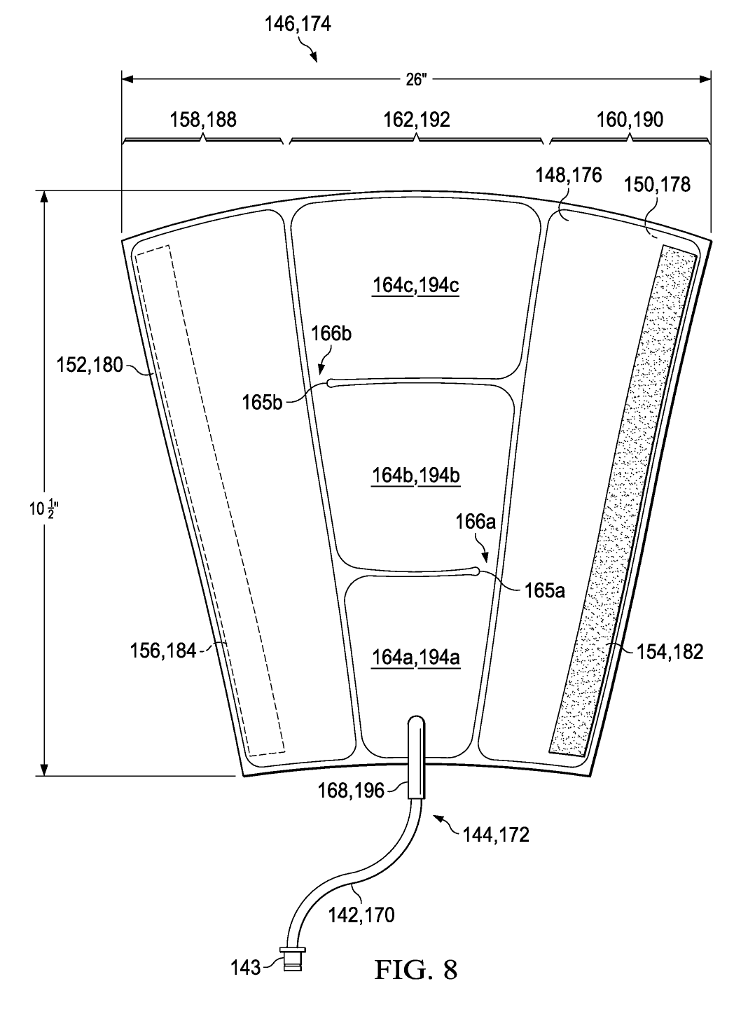

Referring now to FIG. 8, first compressed air line 142 is provided having an inlet end 143 for affixing to first connector 26 for receiving compressed air from pump 16 or to one of connectors 52, 54 of device 15. First compressed air line 142 has an exit end 144 for delivering compressed air. In a preferred embodiment, first compressed air line 142 has a ⅛ inch inner diameter and is 86 inches long.

First limb wrap 146 is affixed to exit end 144 of first compressed air line 142. In one embodiment, first limb wrap 146 has a maximum width of 26 inches and a height of 10½ inches. First limb wrap 146 has an inside sheet 148 and an outside sheet 150 that are joined together by seals, such as heat seals. For example, border seal 152 joins a perimeter of inside sheet 148 and outside sheet 150. In a preferred embodiment, border seal 152 is preferably ¼ inch wide. Outside sheet 150 is provided with hook member patch 154 having a plurality of hook fasteners. Hook member patch 154 is preferably 1½ inches wide. Inside sheet 148 is preferably provided with loop member patch 156 having a plurality of loop fasteners for selectively engaging the plurality of hook fasteners on hook member patch 154 once first limb wrap 146 is wrapped around a limb, e.g. a calf portion, of a patient. In a preferred embodiment, loop member patch 156 is 1½ inches wide.

First limb wrap 146 defines a plurality of areas demarcated by seal lines. The plurality of areas include a first side area 158, a second side area 160, and inflatable area 162 that is preferably between first side area 158 and second side area 160. Inflatable area 162 preferably defines three interconnected chambers 164a, 164b, and 164c, separated by seal lines and connected by air passages 166a and 166b. Stem 168 is provided for engaging exit end 144 of first compressed air line 142. Stem 168 is connected to one of interconnected chambers 164a, 164b, and 164c of inflatable area 162 for delivering compressed air to interconnected chambers 164a, 164b, and 164c.

Second compressed air line 170 has an inlet end for affixing to second connector 128 for receiving compressed air from pump 16. Second compressed air line 170 has an exit end 172 for delivering compressed air. In a preferred embodiment, second compressed air line 170 has a ⅛ inch inner diameter and is 86 inches long.

Second limb wrap 174 is affixed to exit end 172 of second compressed air line 170. Second limb wrap 174 has an inside sheet 176 and an outside sheet 178 joined together with heat seals. For example, inside sheet 176 and outside sheet 178 may be joined with border seal 180. In a preferred embodiment, border seal 180 is ¼ inches wide. Outside sheet 178 is preferably provided with hook member patch 182 having a plurality of hook fasteners. Hook member patch 182 is preferably 1½ inches wide. Inside sheet 176 is preferably provided with loop member patch 184 having a plurality of loop fasteners for selectively engaging the plurality of hook fasteners on hook member patch 182. In a preferred embodiment, loop member patch member 184 is 1½ inches wide.

Second limb wrap 174 defines a plurality of areas demarcated by seal lines. The plurality of areas includes first side area 188, second side area 190 and inflatable area 192 between first side area 188 and second side area 190. Inflatable area 192 defines three interconnected chambers 194a, 194b, and 194c separated by seal lines. A stem 196 is connected to one of interconnected chambers 194a, 194b, and 194c. Stem 196 is provided for engaging exit end 172 of second compressed air line 170.

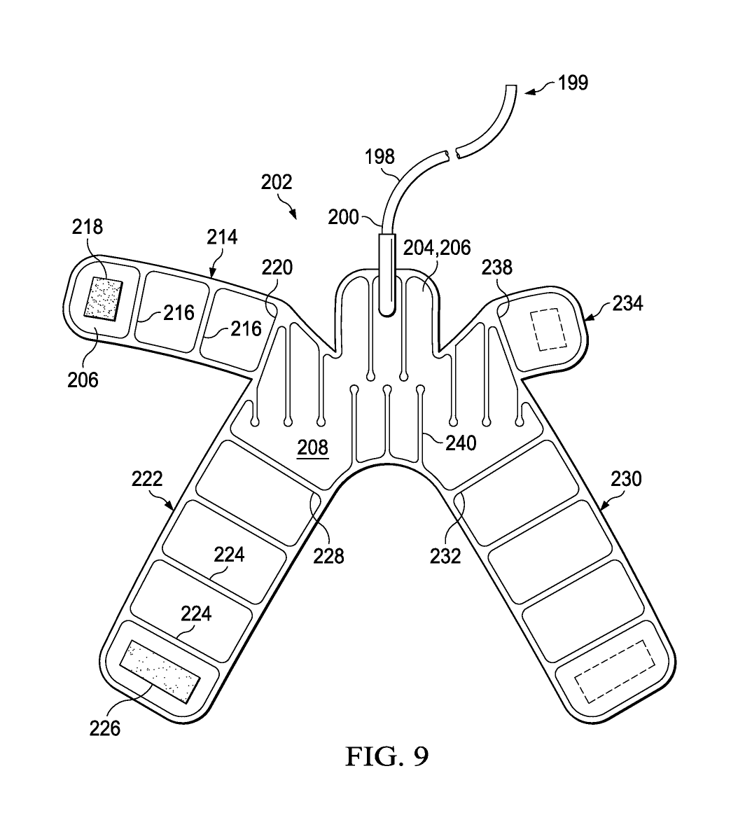

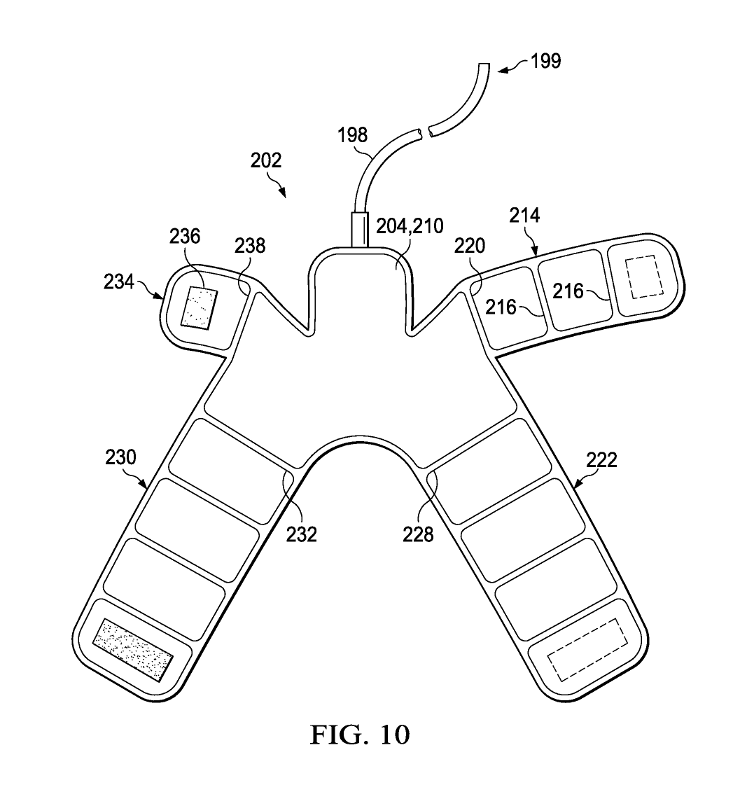

Referring now to FIGS. 9 and 10, third compressed air line 198 has an inlet end 199 affixed to third connector 30 (FIGS. 1, 3, 5) for receiving compressed air from pump 16, or for affixing to one of connectors 52, 54 of device 15. Third compressed air line 198 has an exit end 200 for delivering compressed air. In a preferred embodiment, third compressed air line 198 has an inner diameter of ⅛ inch and length of 86 inches.

Cold therapy shoulder wrap 202 has a chamber portion 204 having a fluid chamber side 206 for containing fluid 208. Chamber portion 204 additionally has an air chamber side 210 for receiving compressed air from exit end 200 of third compressed air line 198. Fluid chamber side 206 and air chamber side 210 are separated by a barrier member, not shown. Cold therapy shoulder wrap 202 additionally has first wrap extension 214 extending therefrom. First wrap extension 214 defines a plurality of dividing seals 216. First wrap extension 214 preferably has a Velcro® compatible loop material 218 on fluid chamber side 206. An interface between first wrap extension 214 and chamber portion 204 defines first strap seal 220. In a preferred embodiment, first strap seal 220 has a width of ⅛ inch.

Cold therapy shoulder wrap 202 additionally has a second wrap extension 222 extending therefrom. Second wrap extension 222 defines a plurality of divider seals 224. In a preferred embodiment, second wrap extension 222 is 22 inches long by 6 inches wide. Preferably, second wrap extension 222 has a hook portion of a hook and loop fastener 226 affixed to fluid chamber side 206 proximate a terminal end of second wrap extension 222. An interface between second wrap extension 222 and chamber portion 204 defines second strap seal 228. Second strap seal 228 preferably has a width of ¼ inch.

Cold therapy shoulder wrap 202 is preferably provided with third wrap extension 230 extending therefrom. An interface between third wrap extension 230 and chamber portion 204 defines third strap seal 232. Third strap 232 preferably has a width of ¼ inch. Cold therapy shoulder wrap 202 is additionally preferably provided with tab extension 234. Tab extension 234 is preferably provided with a hook portion of a hook and loop fastener 236 and is affixed to air chamber side 210 of tab extension 234. Tab extension 234 preferably has dimensions of 2 inches by 3 inches. An interface between tab extension 234 and chamber body 204 defines strap seal 238. Strap seal 238 preferably has a width of ¼ inch.

Fluid chamber side 206 of chamber portion 204 is preferably provided with a plurality of seal barriers 240 for forming a plurality of interconnected chambers 242 for functioning as baffles for fluid 208. In a preferred embodiment, seal barriers 240 have a width of ⅛ inch.

In a preferred embodiment, fluid 208 is located in fluid chamber side 206 of chamber portion 204 of cold therapy shoulder wrap 202 is a gel comprising water, propylene glycol, polyacrylamide, and preservatives. The gel is available from Trann Technologies, Inc., 12526 US Highway 90, Mossy Head, Fla. 32434.

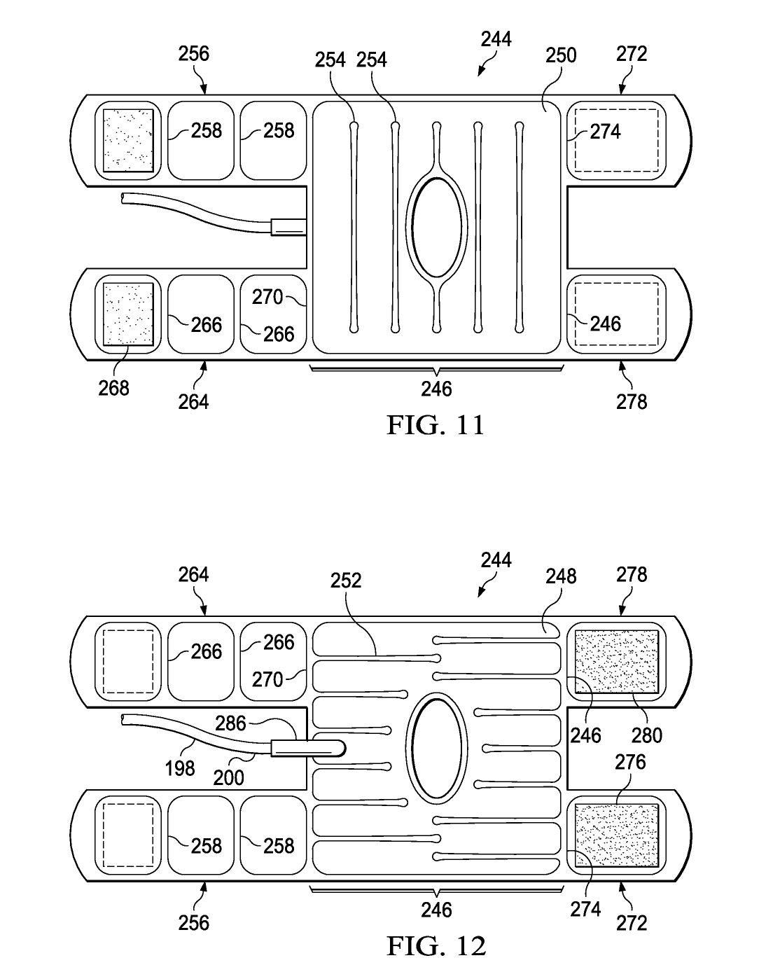

Referring now to FIGS. 11 and 12, in a second embodiment of cold therapy system 10, a cold therapy knee wrap 244 may be provided. Preferably, cold therapy knee wrap 244 has a chamber portion 246. Chamber portion 246 has an air chamber side 248 for receiving compressed air from exit end 200 of third compressed air line 198 that may be affixed to ports 26, 28, 30 of device 13 or ports 52, 54 of device 15. Chamber portion 246 also has a fluid chamber side 250 to contain fluid 208. Air chamber side 248 and fluid chamber side 250 are separated by a divider member (not shown). Air chamber side 248 preferably defines a plurality of seals 252.

Fluid chamber side 250 of chamber portion 246 preferably defines a plurality of seals 254. Fluid chamber side 250 is provided for receiving fluid 208. First wrap extension 256 extends from chamber portion 246. First wrap extension 256 preferably has dimensions of 11 inches by 5 inches. First wrap extension 256 defines a plurality of divider seals 258. First wrap extension 256 preferably has a Velcro® compatible loop material 260 on fluid chamber side 250. An interface between first wrap extension 256 and chamber portion 246 defines first strap seal 262.

Second wrap extension 264 extends from chamber portion 246 and has a preferred dimension of 11 inches by 5 inches. Second wrap extension 264 defines a plurality of divider seals 266. Second wrap extension 264 preferably has a Velcro® compatible loop material 268 on fluid chamber side 250. An interface between second wrap extension 264 and chamber portion 246 defines second strap seal 270.

First tab extension 272 extends from chamber portion 246. An interface between first tab extension 272 and chamber portion 246 defines third strap seal 274. First tab extension 272 has preferred dimensions of 5 inches by 6 inches. First tab extension 272 preferably has a hook portion of a hook and loop fastener 276 affixed to air chamber side 248.

Second tab extension 278 extends from chamber portion 246. Second tab extension 278 has preferred dimensions of 5 inches by 6 inches. Second tab extension 278 is preferably provided with a hook portion of hook and loop fastener 280 affixed to air chamber side 248. An interface between second tab extension 278 and chamber portion 246 defines a fourth strap seal.

Air chamber side 248 of chamber portion 246 of cold therapy knee wrap 244 is preferably provided with interior seals 254 for forming a plurality of areas 284 into which compressed air is dispersed. Fluid chamber side 250 has a plurality of interior seals 254 that function as baffles to position fluid 208. Angle connector 286 extends from air chamber side 248 of chamber portion 246 for connecting to exit end 200 of third compressed air line 198. Angle connector 286 delivers compressed air to air chamber portion 246.

In use, device 13 of cold therapy system 10 operates as follows:

In single limb cuff mode, first solenoid 32 is powered on and pump 16 pressurizes a limb cuff, e.g., first limb wrap 146, to a desired pressure, e.g., 20 mmHg to 50 mmHg, preferably 50 mmHg. Pump 16 is then turned off to allow first limb wrap 146 to deflate. Pump 16 then powers on after a desired time interval, e.g., 60 seconds, to repeat. Although preferred ranges of inflation intervals are listed herein, inflation intervals may be changed in the software as desired, e.g., to accommodate wraps with larger bladders or to adjust cycle time via “rest period” variations.

In double limb cuff mode, first solenoid 32 is powered on and pump 16 pressurizes a limb wrap, e.g., first limb wrap 146, to a desired pressure, e.g., 50 mmHg, preferably 50 mmHg. Pump 16 is then turned off to allow the first limb wrap 146 to deflate. Solenoid 34 is then powered on after a desired time interval, e.g., 25 seconds. Pump 16 then pressurizes a second limb wrap 174 to a desired pressure, e.g., 20 mmHg to 50 mmHg, preferably 50 mmHg. Pump 16 is then turned off. Pump 16 is then powered on after a desired time interval, e.g., 25 seconds, to repeat the process.

In auxiliary cuff only mode, solenoid 36 is powered on and pump 16 pressurizes an auxiliary cuff, e.g., cold therapy shoulder wrap 202 or cold therapy knee wrap 244, to a desired pressure, e.g., 20 mmHg to 50 mmHg, preferably 50 mmHg. Preferably the maximum fill time is 60 seconds. Pump 16 is then turned off to allow joint wrap 202 or 244 to deflate. Pump 16 is then powered on after a desired time interval, e.g., 60 seconds, to repeat.

In single limb+auxiliary cuff mode, solenoid 32 is powered on and pump 16 pressurizes a limb cuff, e.g., first limb wrap 146, to a desired pressure, e.g., 50 mmHg, preferably 50 mmHg. Pump 16 is then turned off to allow first limb wrap 146 to deflate. Solenoid 36 is then powered on after a desired time interval, e.g., 25 seconds. Pump 16 then pressurizes the auxiliary cuff, e.g., cold therapy shoulder wrap 202 or cold therapy knee wrap 244, to maintain a desired pressure, e.g., 20 mmHg to 50 mmHg, preferably 50 mmHg. Pump 16 is then turned off. After a desired time interval, e.g., 25 seconds, pump 16 is powered on to repeat the process.

In double limb and auxiliary cuffs mode, solenoid 32 is powered on and pump 16 pressurizes first limb wrap 146 to a desired pressure, e.g., 50 mmHg, preferably 50 mmHg. Pump 16 is then turned off to allow first limb wrap 146 to deflate. Solenoid 34 is then powered on after a desired time interval, e.g., 15 seconds. Pump 16 then pressurizes second limb wrap 174 to a desired pressure, e.g., 20 mmHg to 50 mmHg, preferably 50 mmHg. Pump 16 is then turned off. Solenoid 36 is then powered on after a desired time interval, e.g., 15 seconds and pump 16 pressurizes an auxiliary cuff, e.g., cold therapy shoulder wrap 202 or cold therapy knee wrap 244, to a desired pressure, e.g., 20 mmHg to 50 mmHg, preferably 50 mmHg. Pump 16 is turned then off to allow auxiliary wrap 202 or 244 to deflate. Pump 16 is then powered on after a desired time interval, e.g., 15 seconds, to repeat.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A compression therapy system comprising:
a portable compression device having a housing;
a pump in said housing;
a tubing assembly in said housing, said tubing assembly for receiving air from said pump, said tubing assembly having a first output and a second output;
a first solenoid in communication with said tubing assembly for selectively routing compressed air from said pump to said first output;
a second solenoid in communication with said tubing assembly for selectively routing compressed air from said pump to said second output;
a power source in communication with said pump;
a first wrap affixed to said first output;
a second wrap affixed to said second output;

2. The compression therapy system according to claim 1 wherein:
said tubing assembly has a third output;
a third solenoid in communication with said tubing assembly for selectively routing compressed air from said pump to said third output;

3. The compression therapy system according to claim 2 further comprising:
a selector accessible by a user for controlling said solenoids.

4. The compression therapy system according to claim 2 further comprising:
a third wrap affixed to said third output.

5. The compression therapy system according to claim 4 wherein:
said third wrap is a cold therapy wrap.

6. The compression therapy system according to claim 5 wherein:
said third wrap defines a fluid chamber that contains a gel.

7. The compression therapy system according to claim 1 wherein:
one of said first wrap and said second wrap is a relatively smaller wrap; and
the other of said first wrap and said second wrap is a relatively larger wrap.

8. The compression therapy system according to claim 1 further comprising:
a timer for timing wrap inflation events for determining which of said first wrap and said second wrap is larger or smaller.

9. The compression therapy system according to claim 8 wherein:
said inflation events are compared to time thresholds selected from the group consisting of a first time threshold indicating that no wrap is present, a second time threshold indicating that a high pressure alarm condition exists, a third time threshold indicating that a wrap is a large wrap, a fourth time threshold indicating a low pressure alarm condition exists, and a fifth time threshold indicating a low pressure alarm condition exists.

10. The compression therapy system according to claim 8 further comprising:
a high pressure switch for providing a signal to indicate when a high pressure target threshold is reached;
a low pressure switch for providing a signal to indicate when a low pressure target threshold is reached.

11. A method of inflating therapy wraps comprising:
activating a pump;
timing an interval until a wrap inflation event occurs.

12. The method according to claim 11 further comprising:
comparing said inflation event to a time threshold selected from the group consisting of a first time threshold indicating that no wrap is present, a second time threshold indicating that a high pressure alarm condition exists, a third time threshold indicating that a wrap is a large wrap, a fourth time threshold indicating a low pressure alarm condition exists, and a fifth time threshold indicating a low pressure alarm condition exists.

13. The method according to claim 11 wherein:
said step of timing said wrap inflation event comprises determining if a wrap is in communication with said pump.

14. The method according to claim 11 further comprises:
after said step of timing said wrap inflation event, determining if a high pressure condition exists.

15. The method according to claim 14 wherein:
said high pressure condition is due to a line kink.

16. The method according to claim 11 further comprising:
after said step of timing said wrap inflation event, determining if one of said attached wraps is a relatively large wrap or a relatively smaller wrap.

17. The method according to claim 11 further comprising:
after said step of timing said wrap inflation event, determining if a low pressure alarm condition exists.

18. The method according to claim 17 wherein:
said low pressure alarm condition is due to a leak.
